(19) United States
(12) Patent Application Publication
(10) Pub. No.: US 2025/0055099 A1
(43) Pub. Date: Feb. 13, 2025

(54) POWER STORAGE DEVICE AND METHOD OF MANUFACTURING THE POWER STORAGE DEVICE

(71) Applicants: Prime Planet Energy & Solutions, Inc., Tokyo (JP); TOYOTA JIDOSHA KABUSHIKI KAISHA, Aichi-ken (JP); PRIMEARTH EV ENERGY CO., LTD., Shizuoka-ken (JP)

(72) Inventors: Yuki SATO, Toyota-shi (JP); Yozo UCHIDA, Toyota-shi (JP); Satoshi FUJIMURA, Toki-shi (JP); Nozomi TATEYAMA, Okazaki-shi (JP); Masahiro UCHIMURA, Miyoshi-shi (JP); Masataka ASAI, Toyota-shi (JP); Shigeru MATSUMOTO, Toyohashi-shi (JP); Takashi TAKIMOTO, Kosai-shi (JP); Shunsuke NAKAMURA, Hamamatsu-shi (JP); Keitaro MACHIDA, Hamamatsu-shi (JP)

(21) Appl. No.: 18/631,054

(22) Filed: Apr. 10, 2024

(30) Foreign Application Priority Data
Aug. 9, 2023 (JP) 2023-130165

(51) Int. Cl. H01M 50/188; H01M 50/103; H01M 50/193; H01M 50/55; H01M 50/562

(52) U.S. Cl. CPC H01M 50/188; H01M 50/103; H01M 50/193; H01M 50/55; H01M 50/562

(57) ABSTRACT

A power storage device has a case member, a first terminal member, a second terminal member, a first resin member hermetically joined to the case member and the first terminal member, and a second resin member hermetically joined to the case member and the second terminal member. The first resin member is made of a first resin material having a resin material linear expansion coefficient α within the range of 1.6×10⁻⁵ to 2.7×10⁻⁵ (1/K), and the second resin member is made of a second resin material that is different from the first resin material and has a resin material flexural modulus E of 17 GPa or less.

### CROSS-REFERENCE TO RELATED APPLICATIONS

This application is based upon and claims the benefit of priority from the prior Japanese Patent Application No. 2023-130165 filed on Aug. 9, 2023, the entire contents of which are incorporated herein by reference.

### BACKGROUND

### Technical Field

The disclosure relates to a power storage device in which a first terminal member is fixed via a first resin member to a case member that constitutes a case, and a second terminal member is fixed via a second resin member to the case member, and also relates to a method of manufacturing the power storage device.

### Related Art

As a power storage device, a battery is known in which a positive terminal member is fixed via a first resin member to a case member (specifically, a case lid member in the form of a rectangular plate) that constitutes a case in the shape of a rectangular parallelepiped box, and a negative terminal member is fixed to the case member via a second resin member. Specifically, the positive terminal member is inserted through a first insertion hole provided in the case lid member, to extend from the inside of the case to the outside, and the first resin member is hermetically joined to the case lid member and the positive terminal member while insulating these members from each other, to fix the positive terminal member to the case lid member. The negative terminal member is also inserted through a second insertion hole provided in the case lid member, to extend from the inside of the case to the outside, and the second resin member is hermetically joined to the case lid member and the negative terminal member while insulating these members from each other, to fix the negative terminal member to the case lid member.

In manufacturing the battery as described above, the first resin member and the second resin member may be subjected to insert molding. That is, in a condition where the positive terminal member is inserted through the first insertion hole of the case lid member and the negative terminal member is inserted through the second insertion hole of the case lid member, the first resin member and the second resin member are insert molded simultaneously using a single resin material. One example of the related art for insert molding the first resin member and the second resin member simultaneously with the single resin material is described in Japanese unexamined patent application publication No. 2022-079172 (JP 2022-079172 A).

### SUMMARY

### Technical Problems

However, it has been found that during the insert molding process described above, cracks extending along the boundary between the first resin member and the positive terminal member may be generated due to cohesive failure in a portion of the first resin member near the boundary, and cracks extending along the boundary between the second resin member and the negative terminal member may be generated due to cohesive failure in a portion of the second resin member near the boundary. If such cracks are generated during insert molding, the cracks may extend further during the actual use of the battery, and the seal between the positive terminal member and the first resin member and the seal between the negative terminal member and the second resin member may be broken.

In this connection, the positive terminal member made of aluminum and the negative terminal member made of copper have different linear expansion coefficients, etc. Thus, when the first resin member and the second resin member are formed using a single resin material, and the resin material used for insert molding is prepared so that the cracks described above do not appear in the first resin member on the positive electrode side, the cracks described above are likely to appear in the second resin member on the negative electrode side. Conversely, it has also been found that if the resin material is prepared so that the cracks described above do not appear in the second resin member on the negative electrode side, the cracks described above are likely to appear in the first resin member on the positive electrode side.

The disclosure was made in view of the situation as described above, and provides a power storage device in which cracks are less likely or unlikely to appear in a first resin member and a second resin member during insert molding, and which can maintain a good seal between a first terminal member made of aluminum and the first resin member and a good seal between a second terminal member made of copper and the second resin member, and a method of manufacturing the power storage device.

### Means of Solving the Problems

(1) One aspect of the disclosure for solving the above problems is a power storage device including a case member having a first insertion hole and a second insertion hole, a first terminal member including aluminum and inserted through the first insertion hole of the case member, a second terminal member including copper and inserted through the second insertion hole of the case member, a first resin member that is insert molded and hermetically joined to the case member and the first terminal member while insulating the case member and the first terminal member from each other, to fix the first terminal member to the case member, and a second resin member that is insert molded and hermetically joined to the case member and the second terminal member while insulating the case member and the second terminal member from each other, to fix the second terminal member to the case member. In the power storage device, the first resin member includes a first resin material having a resin material linear expansion coefficient α within a range of 1.6×10⁻⁵ to 2.7×10⁻⁵ (1/K) (1.6×10⁻⁵≤α≤2.7×10⁻⁵), and the second resin member includes a second resin material that is different from the first resin material and has a resin material flexural modulus E of 17 GPa or less (E≤17).

As described above, conventionally, the first resin member and the second resin member were molded using a single resin material, and it was thus impossible to achieve both a sufficient seal between the first terminal member and the first resin member, and a sufficient seal between the second terminal member and the second resin member. In contrast, in the power storage device described above, the first resin member and the second resin member are molded using different resin materials. The first resin material that forms the first resin member has a resin material linear expansion coefficient α within the range of 1.6×10⁻⁵ to 2.7×10⁻⁵ (1/K), and the second resin material that forms the second resin member has a resin material flexural modulus E of 17 GPa or less. With this arrangement, cracks are less likely or unlikely to appear in the first resin member and the second resin member during insert molding, and good seals can be maintained between the first terminal member and the first resin member and between the second terminal member and the second resin member.

The reason for this is not necessarily clear at this time. The inventor investigated the resin material linear expansion coefficient α and resin material flexural modulus E of the resin materials used for insert molding, and the seal performance between the terminal member and the resin member (see FIG. 11 to FIG. 14). The details will be described below.

As a result, in relation to the first terminal member made of aluminum, the magnitude of the resin material flexural modulus E of the first resin material does not have much effect on the seal performance between the first terminal member and the first resin member (see FIG. 12). On the other hand, the magnitude of the resin material linear expansion coefficient α of the first resin material has significant effect on the seal performance between the first terminal member and the first resin member (see FIG. 11). It has been found that a good seal can be maintained when the value of the resin material linear expansion coefficient α is within the above-indicated range.

In relation to the second terminal member made of copper, the magnitude of the resin material linear expansion coefficient α of the second resin material does not have much effect on the seal performance between the second terminal member and the second resin member (see FIG. 14). On the other hand, the magnitude of the resin material flexural modulus E of the second resin material has significant effect on the seal performance between the second terminal member and the second resin member (see FIG. 13). It has been found that a good seal can be maintained when the value of the resin material flexural modulus E is within the above-indicated range.

The temperature range of the “resin material linear expansion coefficient α” of the first resin material is −40° C. to 65° C. A specific method of measuring the resin material linear expansion coefficient α will be described below.

The “resin material flexural modulus E” of the second resin material is obtained by conducting a three-point bending test using test specimens (10 mm long×1.5 mm wide×1.5 mm thick) of the second resin material. A specific method of measuring the resin material flexural modulus E will be described below.

It is preferable to set the resin material flexural modulus E of the second resin material to 10 GPa or higher (10≤E≤17), for the reason as follows. If the resin material flexural modulus E is too small, the strength of the second resin member is likely to be significantly reduced, and the stress generated in the second resin member during insert molding may exceed the strength of the second resin member, causing cracks to appear in the second resin member.

Examples of the “power storage device” include secondary batteries, such as a lithium-ion secondary battery, sodium-ion secondary battery, and a calcium-ion secondary battery, and capacitors, such as a lithium-ion capacitor.
(2) In the power storage device described in (1), the first resin material may include a thermoplastic first main resin, a thermoplastic first elastomer, and a first filler, and the second resin material may include a thermoplastic second main resin, a thermoplastic second elastomer, and a second filler.

As described above, when the resin material having the thermoplastic first elastomer and the first filler in addition to the thermoplastic first main resin is used as the first resin material, the magnitude of the resin material linear expansion coefficient α of the first resin material can be easily adjusted. Also, when the resin material having the thermoplastic second elastomer and the second filler in addition to the thermoplastic second main resin is used as the second resin material, the magnitude of the resin material flexural modulus E of the second resin material can be easily adjusted.

The term “main resin” refers to the material with the highest weight percentage among the materials that constitute the resin material and exclude the filler. For example, thermoplastic resins, such as polyethylene (PE), polypropylene (PP), polybutylene (PB), polyphenylene sulfide (PPS), polytetrafluoroethylene (PTFE), and perfluoroalkoxyalkane (PFA), may be used as the “thermoplastic main resin”.

Examples of the “thermoplastic elastomer” include thermoplastic polyurethane elastomer (TPU) obtained from diisocyanate, such as 4,4′diphenylmethane diisocyanate (MDI), and high molecular weight diol, etc. As the high molecular weight diol, polyester diol (PES), polyether diol (PET), polycaprolactone diol (PCL), polycarbonate diol (PCD), etc. may be used, for example.

Examples of the “filler” include glass filler made of alkali glass, E-glass, etc., alumina filler made of alumina, potassium titanate filler made of potassium titanate, etc. The shape of the “filler” includes, for example, spherical, plate-like, fibrous, needle-like, and so forth.

The first resin material may include materials other than the first main resin, first elastomer, and first filler described above. The second resin material may include materials other than the second main resin, second elastomer, and second filler described above.
(3) In the power storage device described in (1) or (2), the first terminal member may include a first terminal seal portion to which the first resin member is hermetically joined, and first nanocolumns with a height of 50 nm or more formed by joining particles containing aluminum and having a diameter of 100 nm or less together like strings of beads, into the form of columns, stand numerously on a surface of the first terminal seal portion. The first resin member may be hermetically joined to the first terminal seal portion with the first resin material filling gaps between the first nanocolumns standing numerously. The second terminal member may include a second terminal seal portion to which the second resin member is hermetically joined, and second nanocolumns with a height of 50 nm or more formed by joining particles containing copper and having a diameter of 100 nm or less together like strings of beads, into the form of columns, stand numerously on a surface of the second terminal seal portion. The second resin member may be hermetically joined to the second terminal seal portion with the second resin material filling gaps between the second nanocolumns standing numerously.

In the power storage device described above, the above-mentioned first nanocolumns stand numerously on the surface of the first terminal seal portion of the first terminal member, and the first resin material fills gaps between the first nanocolumns so that the first resin member is hermetically joined to the first terminal seal portion. Thus, the joint strength between the first terminal seal portion of the first terminal member and the first resin member can be increased, and a particularly good seal can be maintained between the first terminal member and the first resin member.

Also, the above-mentioned second nanocolumns stand numerously on the surface of the second terminal seal portion of the second terminal member, and the second resin material fills gaps between the second nanocolumns so that the second resin member is hermetically joined to the second terminal seal portion. Thus, the joint strength between the second terminal seal portion of the second terminal member and the second resin member can be increased, and a particularly good seal can be maintained between the second terminal member and the second resin member.

The “particles containing aluminum” that constitute the first nanocolumns include, for example, particles made of aluminum, particles made of aluminum oxide, particles made of aluminum and aluminum oxide, etc. The “particles containing copper” that constitute the second nanocolumns include, for example, particles made of copper, particles made of copper oxide, particles made of copper and copper oxide, etc.
(4) Another aspect is a method of manufacturing a power storage device including a case member having a first insertion hole and a second insertion hole, a first terminal member including aluminum and inserted through the first insertion hole of the case member, a second terminal member including copper and inserted through the second insertion hole of the case member, a first resin member that is insert molded and hermetically joined to the case member and the first terminal member while insulating the case member and the first terminal member from each other, to fix the first terminal member to the case member, and a second resin member that is insert molded and hermetically joined to the case member and the second terminal member while insulating the case member and the second terminal member from each other, to fix the second terminal member to the case member, wherein the first resin member includes a first resin material having a resin material linear expansion coefficient α within a range of 1.6×10⁻⁵ to 2.7×10⁻⁵ (1/K) (1.6×10⁻⁵≤α≤2.7×10⁻⁵), and the second resin member includes a second resin material that is different from the first resin material and has a resin material flexural modulus E of 17 GPa or less (E≤17). The method of manufacturing the power storage device includes a first insert molding of insert molding the first resin member, using the first resin material having the resin material linear expansion coefficient α, in a condition where the first terminal member is inserted through the first insertion hole of the case member, and a second insert molding of insert molding the second resin member, using the second resin material having the resin material flexural modulus E, in a condition where the second terminal member is inserted through the second insertion hole of the case member.

In the method of manufacturing the power storage device described above, the first resin member is insert molded using the first resin material having the resin material linear expansion coefficient α described above in the first insert molding; therefore, cracks are less likely or unlikely to be generated in the first resin member during molding and a good seal can be maintained between the first terminal member and the first resin member. Also, the second resin member is insert molded using the second resin material having the resin material flexural modulus E described above in the second insert molding; therefore, cracks are less likely or unlikely to be generated in the second resin member during molding, and a good seal can be maintained between the second terminal member and the second resin member. The first insert molding and the second insert molding may be performed separately or simultaneously.
(5) In the method of manufacturing the power storage device described in (4), the second insert molding may be performed first, and the first insert molding may be then performed.

The first terminal member made of aluminum has a larger linear expansion coefficient than the second terminal member made of copper. Therefore, if the first insert molding is performed first, cracks are likely to appear in the first resin member due to temperature changes in the subsequent second insert molding. In contrast, in the method of manufacturing the power storage device described above, the second insert molding is performed first; therefore, the first resin member is not present in the second insert molding, and cracks do not appear in the first resin member.
(6) In the method of manufacturing the power storage device described in (4) or (5), the first terminal member may include a first terminal seal portion to which the first resin member is hermetically joined, and first nanocolumns with a height of 50 nm or more formed by joining particles containing aluminum and having a diameter of 100 nm or less together like strings of beads, into the form of columns, stand numerously on a surface of the first terminal seal portion. The first resin member may be hermetically joined to the first terminal seal portion with the first resin material filling gaps between the first nanocolumns standing numerously. The second terminal member may include a second terminal seal portion to which the second resin member is hermetically joined, and second nanocolumns with a height of 50 nm or more formed by joining particles containing copper and having a diameter of 100 nm or less together like strings of beads, into the form of columns, stand numerously on a surface of the second terminal seal portion. The second resin member may be hermetically joined to the second terminal seal portion with the second resin material filling gaps between the second nanocolumns standing numerously. The method may further include a first nanocolumn formation of applying a pulse oscillation laser beam to the first terminal seal portion of the first terminal member while shifting an irradiation position, before the first insert molding, to form the first nanocolumns standing numerously on the first terminal seal portion, and a second nanocolumn formation of applying a pulse oscillation laser beam to the second terminal seal portion of the second terminal member while shifting an irradiation position, before the second insert molding, to form the second nanocolumns standing numerously on the second terminal seal portion. The first insert molding may include molding the first resin member while filling the gaps between the numerously standing first nanocolumns of the first terminal seal portion with the first resin material, and the second insert molding may include molding the second resin member while filling the gaps between the numerously standing second nanocolumns of the second terminal seal portion with the second resin material.

In the method of manufacturing the power storage device described above, the above-mentioned first nanocolumns are formed on the surface of the first terminal seal portion by applying the laser beam to the surface as described above in the first nanocolumn formation. Thus, the first nanocolumns can be easily formed on the first terminal seal portion. Then, the first resin member is molded with the first resin material filling gaps between the first nanocolumns in the first insert molding; therefore, the joint strength between the first terminal seal portion of the first terminal member and the first resin member can be increased, and a particularly good seal can be maintained between the first terminal member and the first resin member.

Also, the above-mentioned second nanocolumns are formed on the surface of the second terminal seal portion by applying the laser beam to the surface as described above in the second nanocolumn formation. Thus, the second nanocolumns can be easily formed on the second terminal seal portion. Then, the second resin member is molded with the second resin material filling gaps between the second nanocolumns in the second insert molding; therefore, the joint strength between the second terminal seal portion of the second terminal member and the second resin member can be increased, and a particularly good seal can be maintained between the second terminal member and the second resin member.

### BRIEF DESCRIPTION OF THE DRAWINGS

FIG. 1 is a perspective view of a battery according to one embodiment;

FIG. 2 is a partially broken cross-sectional view of the battery according to the embodiment, taken along the battery height direction and the battery width direction;

FIG. 3A is a partially enlarged cross-sectional view of a positive terminal member (negative terminal member), a first resin member (second resin member), and their vicinity of the battery according to the embodiment, the partially enlarged cross-sectional view being taken along the battery height direction and the battery width direction;

FIG. 3B is a partially enlarged cross-sectional view of the positive terminal member (negative terminal member), the first resin member (second resin member), and their vicinity of the battery according to the embodiment, the partially enlarged cross-sectional view being taken along the battery height direction and the battery thickness direction;

FIG. 4 is a partially enlarged cross-sectional view of a surface and its vicinity of a positive terminal seal portion (negative terminal seal portion, first lid seal portion, second lid seal portion) of the battery according to the embodiment;

FIG. 5 is an explanatory view showing a cross section of a first resin material (second resin material) in connection with the methods of measuring the resin material linear expansion coefficient α and the resin material flexural modulus E;

FIG. 6 is an explanatory view showing the method of measuring the resin material flexural modulus E;

FIG. 7 is a flowchart of a method of manufacturing the battery according to the embodiment;

FIG. 8 is an explanatory view showing a positive electrode nanocolumn formation process (negative electrode nanocolumn formation process, lid nanocolumn formation process) in connection with the method of manufacturing the battery according to the embodiment;

FIG. 9A is an explanatory view showing insertion of the negative terminal member through a second insertion hole of a case lid member in a second insert molding process, in connection with the method of manufacturing the battery according to the embodiment;

FIG. 9B is an explanatory view showing formation of the second resin member in the second insert molding process, in connection with the method of manufacturing the battery according to the embodiment;

FIG. 10A is an explanatory view showing insertion of the positive terminal member through a first insertion hole of the case lid member in a first insert molding process, in connection with the method of manufacturing the battery according to the embodiment;

FIG. 10B is an explanatory view showing formation of the first resin member in the first insert molding process, in connection with the method of manufacturing the battery according to the embodiment;

FIG. 11 is a graph showing the relationship between the resin material linear expansion coefficient α of the first resin material of the positive electrode, and the length of cracks appearing in the first resin member after a cooling and heating cycle test;

FIG. 12 is a graph showing the relationship between the resin material flexural modulus E of the first resin material of the positive electrode, and the length of cracks appearing in the first resin member after the cooling and heating cycle test;

FIG. 13 is a graph showing the relationship between the resin material flexural modulus E of the second resin material of the negative electrode, and the length of cracks appearing in the second resin member after the cooling and heating cycle test; and

FIG. 14 is a graph showing the relationship between the resin material linear expansion coefficient α of the second resin material of the negative electrode, and the length of cracks appearing in the second resin member after the cooling and heating cycle test.

### DETAILED DESCRIPTION OF THE EXEMPLARY EMBODIMENTS

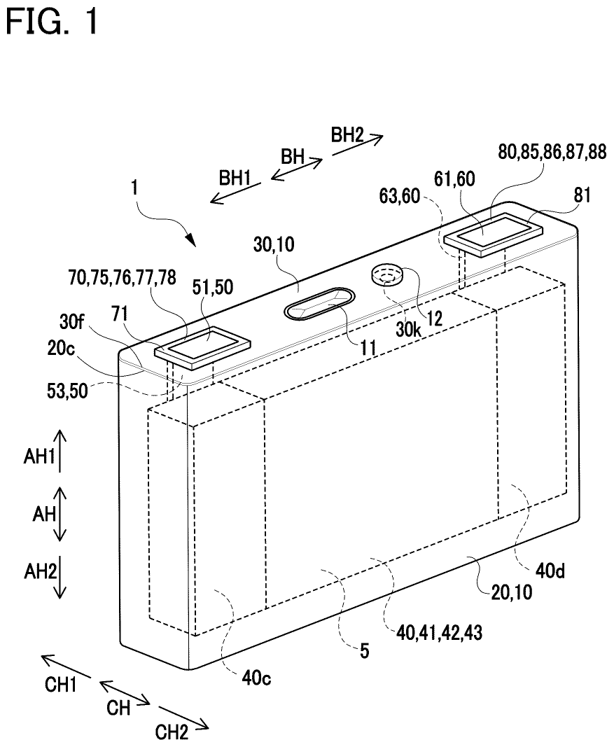

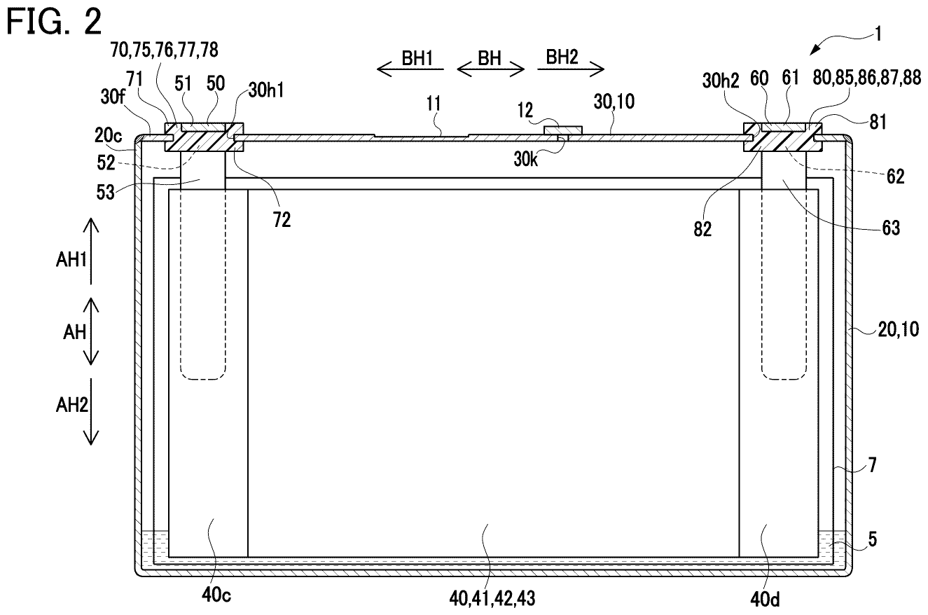

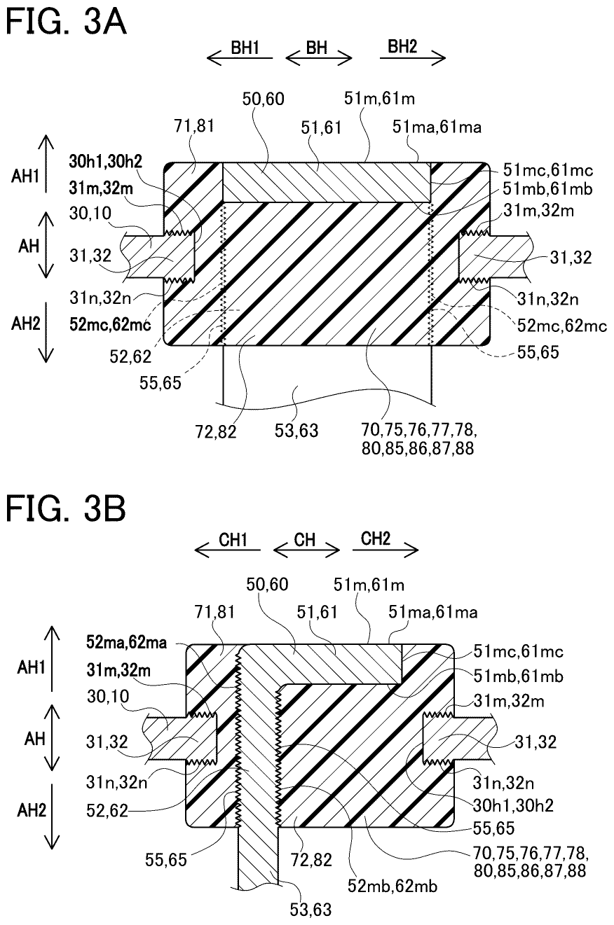

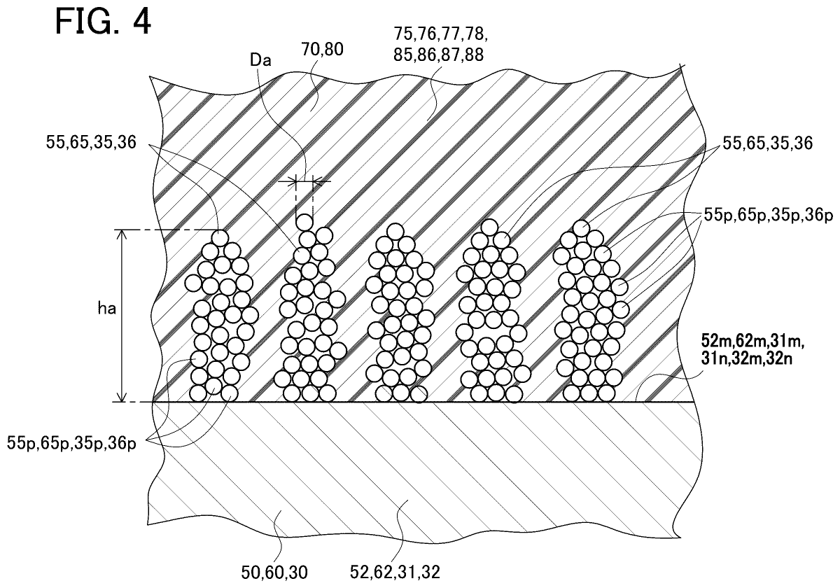

In the following, one embodiment of the disclosure will be described with reference to the drawings. FIG. 1 is a perspective view of a battery (one example of the power storage device of the disclosure) 1 according to the embodiment, and FIG. 2 is a partially broken cross-sectional view of the battery 1. FIG. 3A and FIG. 3B are partially enlarged cross-sectional views of a positive terminal member 50 (a negative terminal member 60), a first resin member 70 (a second resin member 80), and their vicinities. FIG. 4 is a partially enlarged cross-sectional view of a surface 52m (a surface 62m) of a positive terminal seal portion 52 (a negative terminal seal portion 62), etc., and its vicinity. In the following description, the battery height direction AH, battery width direction BH, and battery thickness direction CH of the battery 1 are defined as the directions indicated in FIG. 1 and FIG. 2. The battery 1 is a sealed lithium-ion secondary battery having a rectangular (rectangular parallelepiped) shape, which is installed on a vehicle, such as a hybrid vehicle, plug-in hybrid vehicle, and an electric vehicle.

The battery 1 consists of a case 10, an electrode body 40 housed in the case 10, the positive terminal member (one example of the first terminal member of the disclosure) 50 fixed to the case 10 via the first resin member 70, the negative terminal member (one example of the second terminal member of the disclosure) 60 fixed to the case 10 via the second resin member 80, and so forth. In the case 10, the electrode body 40 is covered with a bag-like insulating holder 7 made from an insulating film. The case 10 also contains electrolyte 5, and the electrode body 40 is impregnated with a part of the electrolyte 5, while the rest of the electrolyte 5 is collected and kept on a bottom wall of the case 10.

The case 10 is shaped like a rectangular parallelepiped box and made of metal (aluminum in this embodiment). The case 10 consists of a case body 20 that is in the form of a rectangular tube with a bottom and a rectangular opening portion 20c and houses the electrode body 40 therein, and a case lid member 30 in the form of a rectangular plate that closes the opening portion 20c of the case body 20. In this embodiment, the case lid member 30 corresponds to the “case member” described above. The opening portion 20c of the case body 20 and a peripheral portion 30f of the case lid member 30 are hermetically welded together over the entire circumference thereof.

The case lid member 30 of the case 10 is provided with a safety valve 11 that breaks and opens when the internal pressure of the case 10 exceeds the valve opening pressure. The case lid member 30 is also provided with a liquid inlet 30k that extends through the case lid member 30, and the liquid inlet 30k is hermetically sealed with a disc-shaped sealing member 12 made of aluminum.

The electrode body 40 housed in the case 10 is of a rectangular parallelepiped, stacked type, and has a plurality of positive electrode sheets 41 and a plurality of negative electrode sheets 42 alternately stacked in the battery thickness direction CH via separators 43 each made from a porous resin film. Each of the positive electrode sheets 41, negative electrode sheets 42, and separators 43 has a rectangular shape extending in the battery height direction AH and the battery width direction BH.

Each of the positive electrode sheets 41 consists of a positive current collecting foil made from an aluminum foil, and positive active material layers containing positive active material particles and respectively formed on both main surfaces of the positive current collecting foil. A part of the positive current collecting foil extends to one side BH1 in the battery width direction BH, and provides a positive-electrode foil exposed portion that is exposed without the positive active material layers present on both main surfaces of the positive current collecting foil. The positive-electrode foil exposed portions of the respective positive electrode sheets 41 are stacked in the foil thickness direction, to form a positive current collector 40c. The positive current collector 40c is conductively connected to the positive terminal member 50 described below.

Each of the negative electrode sheets 42 consists of a negative current collecting foil made from a copper foil, and negative active material layers containing negative active material particles and respectively formed on both main surfaces of the negative current collecting foil. A part of the negative current collecting foil extends to the other side BH2 in the battery width direction BH, and provides a negative-electrode foil exposed portion that is exposed without the negative active material layers present on both main surfaces of the negative current collecting foil. The negative-electrode foil exposed portions of the respective negative electrode sheets 42 are stacked in the foil thickness direction, to form a negative current collector 40d. The negative current collector 40d is conductively connected to the negative terminal member 60 described below.

A portion of the case lid member 30 near its end on one side BH1 in the battery width direction BH has a rectangular first insertion hole 30h1 extending through the case lid member 30, and a portion of the case lid member 30 near its end on the other side BH2 in the battery width direction BH has a rectangular second insertion hole 30h2 extending through the case lid member 30. The positive terminal member 50 made of aluminum is inserted through the first insertion hole 30h1, and the positive terminal member 50 is fixed to the case lid member 30 while being insulated from the case lid member 30 via the first resin member 70. Also, the negative terminal member 60 made of copper is inserted through the second insertion hole 30h2, and the negative terminal member 60 is fixed to the case lid member 30 while being insulated from the case lid member 30 via the second resin member 80.

Initially, the positive electrode will be described. The positive terminal member 50 (see FIG. 1, FIG. 2, FIG. 3A, and FIG. 3B) is formed by pressing an aluminum plate, and consists of a positive terminal outer portion 51 in the form of a rectangular plate extending in the battery width direction BH and the battery thickness direction CH and located on the outer side (the upper side AH1 in the battery height direction AH) of the case lid member 30, a positive terminal inner portion 53 located on the inner side (the lower side AH2 in the battery height direction AH) of the case lid member 30 and extending in the battery height direction AH, and a positive terminal seal portion (one example of the first terminal seal portion of the disclosure) 52 that connects to the positive terminal outer portion 51 and the positive terminal inner portion 53 via the first insertion hole 30h1. The positive terminal seal portion 52 is bent at an end portion of the positive terminal outer portion 51 on one side CH1 in the battery thickness direction CH, and extends to the lower side AH2 through the first resin member 70 that will be described below in the battery height direction AH. The positive terminal inner portion 53 is welded at its distal end portion on the lower side AH2 to the positive current collector 40c of the electrode body 40, to be conductively connected to the positive current collector 40c.

The surface 51m of the positive terminal outer portion 51 has a rectangular top surface 51ma that faces to the upper side AH1, a rectangular inner surface 51mb that faces to the lower side AH2, and an end surface 51mc that connects the top surface 51ma and the inner surface 51mb, and the positive terminal outer portion 51 is joined at the inner surface 51mb and the end surface 51mc to the first resin member 70. In this embodiment, positive electrode nanocolumns which will be described below are not formed on the inner surface 51mb and the end surface 51mc.

On the other hand, the first resin member 70 is hermetically joined to the positive terminal seal portion 52. Specifically, the surface 52m of the positive terminal seal portion 52 has a first major surface 52ma that faces to one side CH1 in the battery thickness direction CH, a second major surface 52mb that faces to the other side CH2 in the battery thickness direction CH, and a pair of end surfaces 52mc that connects the first major surface 52ma and the second major surface 52mb. As shown in FIG. 4, particles 55p made of aluminum and aluminum oxide are joined together like strings of beads, into the form of columns, so that positive electrode nanocolumns 55 (one example of the first nanocolumns of the disclosure) stand together in large numbers on the surface 52m. The diameter Da of each particle 55p is equal to or smaller than 100 nm (Da is equal to about 30 nm in this embodiment), and the height ha of the positive electrode nanocolumn 55 is equal to or larger than 50 nm (ha is equal to about 200 nm in this embodiment). Gaps between the numerously standing positive electrode nanocolumns 55 are filled with a first resin material 75 so that the first resin member 70 that will be described below is hermetically joined to the positive terminal seal portion 52.

The first resin member 70 is also hermetically joined to a first lid seal portion 31 of the case lid member 30 which surrounds the first insertion hole 30h1 (see FIG. 3A and FIG. 3B). Specifically, the first lid seal portion 31 has a rectangular, band-like outer surface 31m that faces outward (to the upper side AH1), and a rectangular, band-like inner surface 31n that faces inward (to the lower side AH2). On these surfaces 31m, 31n, like the surface 52m of the positive terminal seal portion 52 (see FIG. 4), first lid nanocolumns 35 formed by joining particles 35p made of aluminum and aluminum oxide together like strings of beads stand together in large numbers. The diameter Da of each particle 35p is equal to or smaller than 100 nm (Da is equal to about 30 nm in this embodiment), and the height ha of the first lid nanocolumn 35 is equal to or larger than 50 nm (ha is equal to about 200 nm in this embodiment). Gaps between the numerously standing first lid nanocolumns 35 are filled with the first resin material 75 so that the first resin member 70 that will be described below is hermetically joined to the first lid seal portion 31.

Next, the negative electrode will be described. The negative terminal member 60 has substantially the same shape as the positive terminal member 50 (see FIG. 1 to FIG. 3B). The negative terminal member 60 is formed by pressing a copper plate, and consists of a negative terminal outer portion 61 in the form of a rectangular plate extending in the battery width direction BH and the battery thickness direction CH and located on the outer side (the upper side AH1) of the case lid member 30, a negative terminal inner portion 63 located on the inner side (the lower side AH2) of the case lid member 30 and extending in the battery height direction AH, and a negative terminal seal portion (one example of the second terminal seal portion of the disclosure) 62 that connects to the negative terminal outer portion 61 and the negative terminal inner portion 63 via the second insertion hole 30h2. The negative terminal seal portion 62 is bent at an end portion of the negative terminal outer portion 61 on one side CH1 in the battery thickness direction CH, and extends to the lower side AH2 through the second resin member 80 that will be described below in the battery height direction AH. The negative terminal inner portion 63 is welded at its distal end portion on the lower side AH2 to the negative current collector 40d of the electrode body 40, to be conductively connected to the negative current collector 40d.

The surface 61m of the negative terminal outer portion 61 has a rectangular top surface 61ma that faces to the upper side AH1, a rectangular inner surface 61mb that faces to the lower side AH2, and an end surface 61mc that connects the top surface 61ma and the inner surface 61mb, and the negative terminal outer portion 61 is joined at the inner surface 61mb and the end surface 61mc to the second resin member 80. In this embodiment, negative electrode nanocolumns which will be described below are not formed on the inner surface 61mb and the end surface 61mc.

On the other hand, the second resin member 80 is hermetically joined to the negative terminal seal portion 62. Specifically, the surface 62m of the negative terminal seal portion 62 has a first major surface 62ma that faces to one side CH1 in the battery thickness direction CH, a second major surface 62mb that faces to the other side CH2 in the battery thickness direction CH, and a pair of end surfaces 62mc that connects the first major surface 62ma and the second major surface 62mb. Particles 65p made of copper and copper oxide are joined together like strings of beads, into the form of columns, so that negative electrode nanocolumns 65 (one example of the second nanocolumns of the disclosure) stand together in large numbers on the surface 62m (see FIG. 4). The diameter Da of each particle 65p is equal to or smaller than 100 nm (Da is equal to about 30 nm in this embodiment), and the height ha of the negative electrode nanocolumn 65 is equal to or larger than 50 nm (ha is equal to about 200 nm in this embodiment). Gaps between the numerously standing negative electrode nanocolumns 65 are filled with a second resin material 85 so that the second resin member 80 that will be described below is hermetically joined to the negative terminal seal portion 62.

The second resin member 80 is also hermetically joined to a second lid seal portion 32 of the case lid member 30 which surrounds the second insertion hole 30h2 (see FIG. 3A and FIG. 3B). Specifically, the second lid seal portion 32 has a rectangular, band-like outer surface 32m that faces outward (to the upper side AH1), and a rectangular, band-like inner surface 32n that faces inward (to the lower side AH2). On these surfaces 32m, 32n, like the outer surface 31m and inner surface 31n of the first lid seal portion 31 (see FIG. 4), second lid nanocolumns 36 formed by joining particles 36p made of aluminum and aluminum oxide together like strings of beads stand together in large numbers. The diameter Da of each particle 36p is equal to or smaller than 100 nm (Da is equal to about 30 nm in this embodiment), and the height ha of the second lid nanocolumn 36 is equal to or larger than 50 nm (ha is equal to about 200 nm in this embodiment). Gaps between the numerously standing second lid nanocolumns 36 are filled with the second resin material 85 so that the second resin member 80 that will be described below is hermetically joined to the second lid seal portion 32.

Next, the first resin member 70 of the positive electrode will be described (see FIG. 1 to FIG. 4). The first resin member 70 is joined to the case lid member 30 and the positive terminal member 50 and fixes the positive terminal member 50 to the case lid member 30, while insulating the case lid member 30 and the positive terminal member 50 from each other. More specifically, the first resin member 70 is hermetically joined to the positive terminal seal portion 52 such that gaps between the numerously standing positive electrode nanocolumns 55 of the positive terminal seal portion 52 of the positive terminal member 50 are filled with the first resin material 75 that will be described below. The first resin member 70 is also hermetically joined to the first lid seal portion 31 such that gaps between the numerously standing first lid nanocolumns 35 of the first lid seal portion 31 of the case lid member 30 are filled with the first resin material 75.

The first resin member 70 consists of a first resin outer portion 71 located on the outer side (the upper side AH1) of the case lid member 30, and a first resin inner portion 72 that is located on the inner side (the lower side AH2) of the case lid member 30 and within the first insertion hole 30h1 and connects to the first resin outer portion 71. The first resin member 70 is made of the first resin material 75 of which the resin material linear expansion coefficient α in the temperature range of −40 to 65° C. is within the range of 1.6×10⁻⁵ to 2.7×10⁻⁵ (1/K). In this embodiment, α=2.3×10⁻⁵ (1/K).

The first resin material 75 is comprised of a thermoplastic first main resin 76, a thermoplastic first elastomer 77, and a first filler 78. Specifically, in this embodiment, the first main resin 76 is polyphenylene sulfide (PPS). The first elastomer 77 is a thermoplastic polyurethane elastomer (TPU) obtained from 4,4′diphenylmethane diisocyanate (MDI) and polyester diol (PES). The first filler 78 is a glass filler that is fibrous (generally, 10 μm in diameter×300 μm in length) and made of alkali glass. The weight ratio of the first main resin 76, the first elastomer 77, and the first filler 78 is as follows: first main resin:first elastomer:first filler=40:10:50.

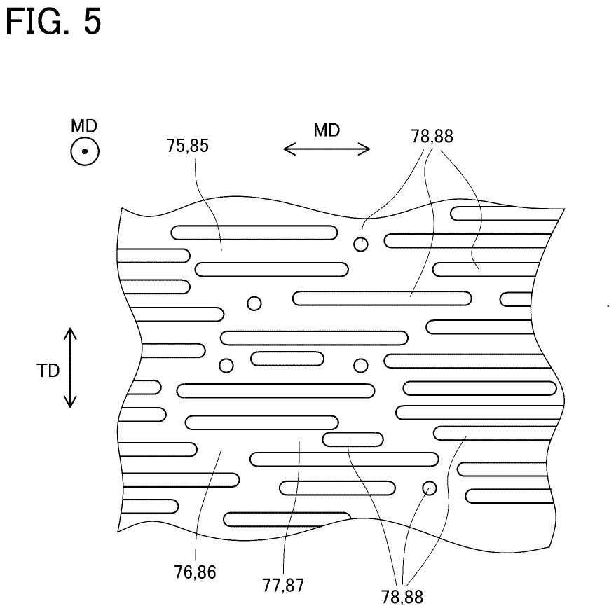

Here, a method of measuring the resin material linear expansion coefficient α of the first resin material 75 will be described (see FIG. 5). In this embodiment, the first filler 78 contained in the first resin material 75 is fibrous; therefore, when the first filler 78 dispersed in the first resin material 75 is oriented, the resin material linear expansion coefficient α of the first resin material 75 becomes directional. That is, when the first filler 78 is oriented in the direction in which the plane extends, the first-direction linear expansion coefficient αM measured in the first directions MD (in FIG. 5, the lateral direction and the direction orthogonal to the plane of paper) along the longitudinal direction of the first filler 78 and the second-direction linear expansion coefficient αT measured in the second direction TD (in FIG. 5, the vertical direction) orthogonal to the first directions MD have different magnitudes. Thus, the first-direction linear expansion coefficient αM and the second-direction linear expansion coefficient αT are respectively obtained, and the average value is calculated as the resin material linear expansion coefficient α(α=(αM+αT)/2).

More specifically, the first-direction linear expansion coefficient αM and the second-direction linear expansion coefficient αT of the first resin material 75 are obtained by a digital image correlation method (DIC). First, a rectangular parallelepiped test specimen of the first resin material 75 in which the first filler 78 is oriented in the directions in which the plane extends is prepared. The test specimen is placed on a specimen cooling and heating stage (e.g., Large Specimen Cooling and Heating Stage for Microscope 10083L manufactured by Japan High Tech Co., Ltd.), such that a cross section (see FIG. 5) taken along the first direction MD and the second direction TD is visible. Then, an initial image of the cross section of the test specimen is acquired for the test specimen at 25° C. The image is acquired using, for example, Digital Microscope VHX-8000 manufactured by Keyence Corporation.

Then, the test specimen is cooled to −40° C. and then heated to 65° C., and images of the cross section of the test specimen are acquired at −40° C., 0° C., 25° C., 50° C., and 65° C., respectively. Then, the obtained images are analyzed using a DIC system (e.g., DIC System ARAMIS manufactured by GOM) to obtain an approximate straight line y=ax+b indicating the relationship between the temperature x and the strain y for the first direction MD, and the slope a of the straight line is determined as the first-direction linear expansion coefficient αM for the first direction MD. For the second direction TD, too, an approximate straight line y=cx+d indicating the relationship between the temperature x and the strain y is obtained, and the slope c of the straight line is determined as the second-direction linear expansion coefficient αT for the second direction TD. Furthermore, the average value of these coefficients is calculated ((αM+αT)/2), and this value is determined as the resin material linear expansion coefficient α.

Next, the second resin member 80 of the negative electrode will be described (see FIG. 1 to FIG. 4). The second resin member 80 is joined to the case lid member 30 and the negative terminal member 60 and fixes the negative terminal member 60 to the case lid member 30, while insulating the case lid member 30 and the negative terminal member 60 from each other. More specifically, the second resin member 80 is hermetically joined to the negative terminal seal portion 62 such that gaps between the numerously standing negative electrode nanocolumns 65 of the negative terminal seal portion 62 of the negative terminal member 60 are filled with the second resin material 85 that will be described below. The second resin member 80 is also hermetically joined to the second lid seal portion 32 such that gaps between the numerously standing second lid nanocolumns 36 of the second lid seal portion 32 of the case lid member 30 are filled with the second resin material 85.

The second resin member 80 has substantially the same shape as the first resin member 70. The second resin member 80 consists of a second resin outer portion 81 located on the outer side (the upper side AH1) of the case lid member 30, and a second resin inner portion 82 that is located on the inner side (the lower side AH2) of the case lid member 30 and within the second insertion hole 30h2 and connects to the second resin outer portion 81. The second resin member 80 is made of the second resin material 85 that is different from the first resin material 75 and has a resin material flexural modulus E of 17 GPa or less. Furthermore, the resin material flexural modulus E of the second resin material 85 is equal to or higher than 10 GPa. Specifically, in this embodiment, E=16 GPa.

The second resin material 85 is comprised of a thermoplastic second main resin 86, a thermoplastic second elastomer 87, and a second filler 88. In this embodiment, the second main resin 86, the second elastomer 87, and the second filler 88 are the same as the first main resin 76, the first elastomer 77, and the first filler 78, respectively, of the first resin material 75. However, the proportion of the second main resin 86, the second elastomer 87, and the second filler 88 in the second resin material 85 is different from that of the first main resin 76, the first elastomer 77, and the first filler 78 in the first resin material 75. More specifically, the weight ratio of the second main resin 86, the second elastomer 87, and the second filler 88 is as follows: second main resin:second elastomer:second filler=40:15:45.

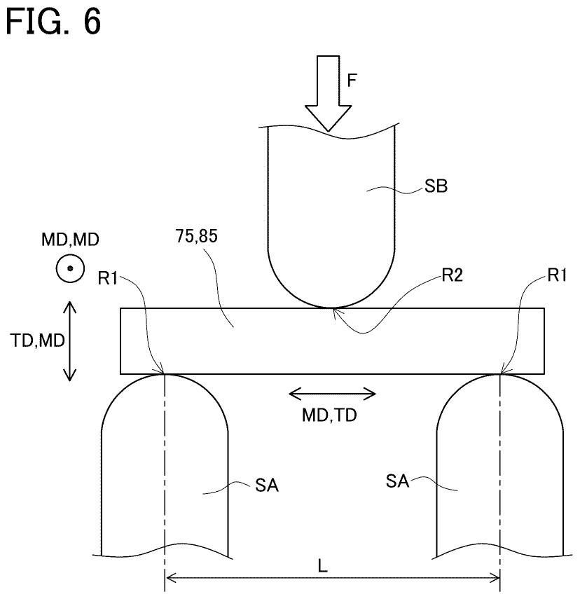

Here, a method of measuring the resin material flexural modulus E of the second resin material 85 will be described (see FIG. 6). In this embodiment, the second filler 88 contained in the second resin material 85 is fibrous; therefore, when the second filler 88 dispersed in the second resin material 85 is oriented, the resin material flexural modulus E of the second resin material 85 becomes directional. That is, when the second filler 88 is oriented in the directions in which the plane extends (see FIG. 5), the first-direction flexural modulus EM for the first directions MD along the longitudinal direction of the second filler 88 and the second-direction flexural modulus ET for the second direction TD orthogonal to the first directions MD have different magnitudes. Thus, the first-direction flexural modulus EM and the second-direction flexural modulus ET are respectively obtained, and the average value is calculated to be the resin material flexural modulus E (E=(EM+ET)/2).

More specifically, the first-direction flexural modulus EM and the second-direction flexural modulus ET are obtained by conducting a three-point bending test. First, two types of rectangular parallelepiped test specimens (10 mm long×1.5 mm wide×1.5 mm thick) of the second resin material 85 in which the second filler 88 is oriented in the directions in which the plane extends are prepared. In one test specimen, the first directions MD coincide with the length direction (the lateral direction in FIG. 6) and width direction (direction orthogonal to the plane of paper in FIG. 6) of the test specimen, and the second direction TD coincides with the thickness direction (the vertical direction in FIG. 6) of the test specimen. In the other test specimen, the second direction TD coincides with the length direction of the test specimen, and the first directions MD coincide with the width direction and thickness direction of the test specimen.

Next, at an ambient temperature of 23° C., the test specimen of the second resin material 85 is placed on a pair of supports SA with a distance L between the points of support being equal to 8 mm, and the center of the test specimen in the length direction is pressed from above to below with a force F of 1 kN by a presser SB. The radius R1 of the tip of the support SA and the radius R2 of the tip of the presser SB are both 1.5 mm. For each test specimen, the first-direction flexural modulus EM and the second-direction flexural modulus ET are obtained, and the average value of these is calculated ((EM+ET)/2) to be the resin material flexural modulus E.

In the battery 1 of this embodiment, the first resin member 70 and the second resin member 80 are formed of different resin materials, as described above. The resin material linear expansion coefficient α of the first resin material 75 that forms the first resin member 70 is within the range of 1.6×10⁻⁵ to 2.7×10⁻⁵ (1/K), and the resin material flexural modulus E of the second resin material 85 that forms the second resin member 80 is equal to or lower than 17 GPa. Furthermore, the resin material flexural modulus E of the second resin material 85 is equal to or higher than 10 GPa. Thus, as described below, cracks are less likely or unlikely to appear in the first resin member 70 and the second resin member 80 during insert molding, thus making it possible to maintain a good seal between the positive terminal member 50 and the first resin member 70 and a good seal between the negative terminal member 60 and the second resin member 80.

Furthermore, in this embodiment, the first resin material 75 has the thermoplastic first elastomer 77 and the first filler 78 in addition to the thermoplastic first main resin 76; therefore, the magnitude of the resin material linear expansion coefficient α of the first resin material 75 can be easily adjusted. Also, the second resin material 85 has the thermoplastic second elastomer 87 and the second filler 88 in addition to the thermoplastic second main resin 86; therefore, the magnitude of the resin material flexural modulus E of the second resin material 85 can be easily adjusted.

In this embodiment, the above-mentioned positive electrode nanocolumns 55 stand together in large numbers on the surface 52m of the positive terminal seal portion 52 of the positive terminal member 50, and the gaps between the positive electrode nanocolumns 55 are filled with the first resin material 75, so that the first resin member 70 is hermetically joined to the positive terminal seal portion 52. This makes it possible to increase the joint strength of the positive terminal seal portion 52 of the positive terminal member 50 and the first resin member 70, and maintain a particularly good seal between the positive terminal member 50 and the first resin member 70.

Also, the above-mentioned negative electrode nanocolumns 65 stand together in large numbers on the surface 62m of the negative terminal seal portion 62 of the negative terminal member 60, and the gaps between the negative electrode nanocolumns 65 are filled with the second resin material 85, so that the second resin member 80 is hermetically joined to the negative terminal seal portion 62. This makes it possible to increase the joint strength of the negative terminal seal portion 62 of the negative terminal member 60 and the second resin member 80, and maintain a particularly good seal between the negative terminal member 60 and the second resin member 80.

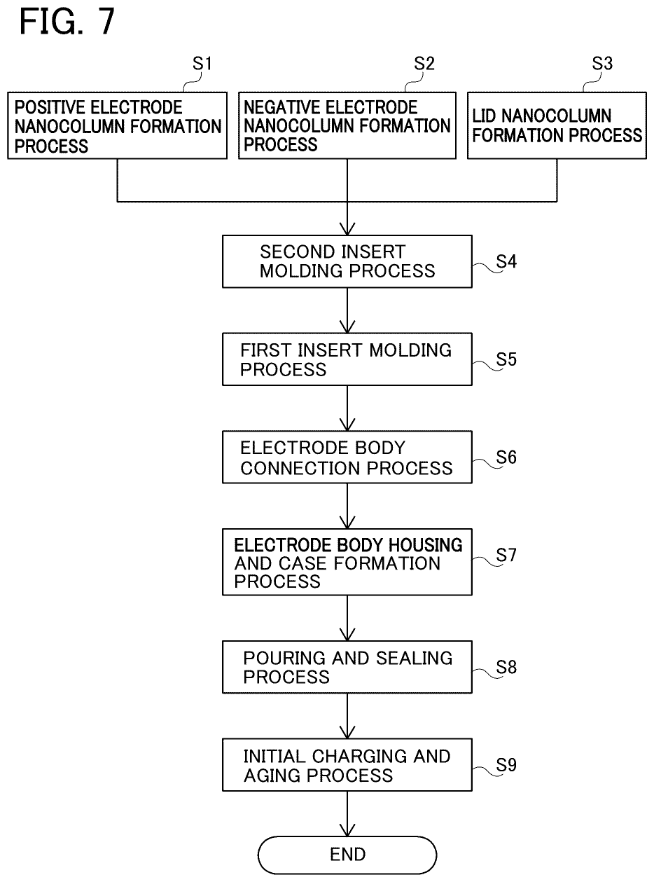

Next, a method of manufacturing the battery 1 will be described (see FIG. 7 to FIG. 10B). First, a case lid member (one example of the case member of the disclosure) 30Z before roughening is prepared. The case lid member 30Z before roughening is obtained by punching an aluminum plate into a predetermined shape and forming the liquid inlet 30k, first insertion hole 30h1, second insertion hole 30h2, and the safety valve 11 in it. A positive terminal member (one example of the first terminal member of the disclosure) 50Z before roughening is also prepared. The positive terminal member 50Z before roughening is obtained by punching an aluminum plate into a predetermined shape and bending it. A negative terminal member (one example of the second terminal member of the disclosure) 60Z before roughening is also prepared. The negative terminal member 60Z before roughening is obtained by punching a copper plate into a predetermined shape and bending it.

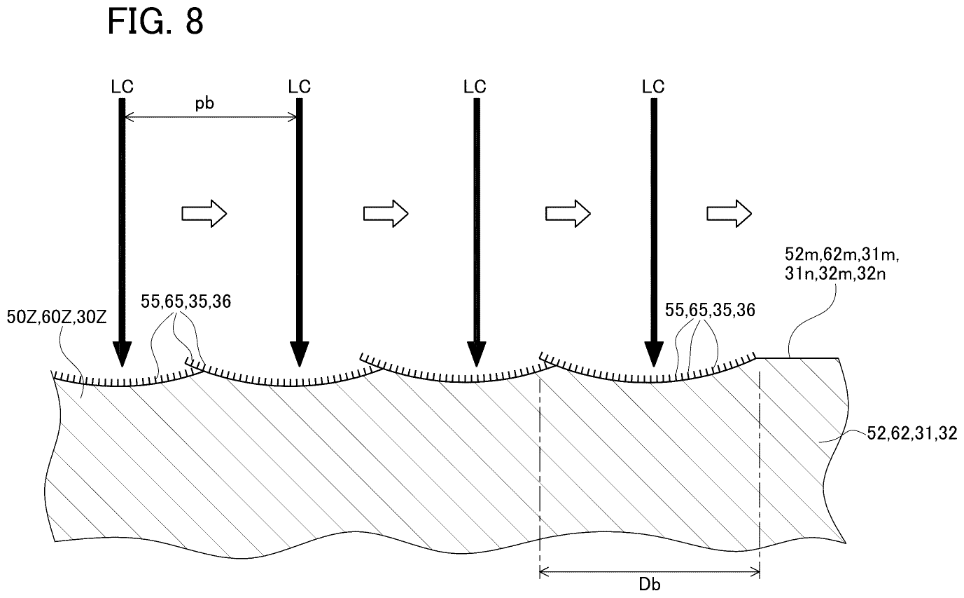

Then, in “positive electrode nanocolumn formation process (first nanocolumn formation process) S1” (see FIG. 7), a pulse oscillation laser beam LC is applied to the positive terminal seal portion 52 of the positive terminal member 50Z while shifting the irradiation position (see FIG. 8) to form the numerously standing positive electrode nanocolumns 55 on the surface 52m of the positive terminal seal portion 52. As described above (see also FIG. 4), the positive electrode nanocolumns 55 are formed by joining the particles 55p made of aluminum and aluminum oxide together like strings of beads, into the form of columns.

In this embodiment, the irradiation conditions of the laser beam are set as follows: the wavelength is 1064 nm, the peak power is 5 KW, the pulse width is 150 ns, the pitch pb is 75 μm, and the spot diameter Db is 80 μm. In the positive terminal seal portion 52, aluminum near the surface 52m is melted in a circular region as seen in plan view which is irradiated with the laser beam LC, and further turns into aluminum vapor. As the temperature of the vapor then decreases, the vapor turns into the particles 55p of aluminum and aluminum oxide, which are deposited on the surface 52m of the positive terminal seal portion 52. By applying the laser beam LC to the positive terminal seal portion 52 while shifting the irradiation position, the particles 55p are deposited and joined together like strings of beads, into the form of columns, to form the positive electrode nanocolumns 55 standing together in large numbers.

Meanwhile, in “negative electrode nanocolumn formation process (second nanocolumn formation process) S2” (see FIG. 7), a pulse oscillation laser beam LC is applied to the negative terminal seal portion 62 of the negative terminal member 60Z while shifting the irradiation position (see FIG. 8) to form the numerously standing negative electrode nanocolumns 65 on the surface 62m of the negative terminal seal portion 62. As described above (see also FIG. 4), the negative electrode nanocolumn 65 are formed by joining the particles 65p made of copper and copper oxide together like strings of beads, into the form of columns.

In this embodiment, the irradiation conditions of the laser beam are set as follows: the wavelength is 1064 nm, the peak power is 20 kW, the pulse width is 50 ns, the pitch pb is 60 μm, and the spot diameter Db is 75 μm. In the negative terminal seal portion 62, copper near the surface 62m is melted in a circular region as seen in plan view which is irradiated with the laser beam LC, and further turns into copper vapor. As the temperature of the vapor then decreases, the vapor turns into the particles 65p of copper and copper oxide, which are deposited on the surface 62m of the negative terminal seal portion 62. By applying the laser beam LC to the negative terminal seal portion 62 while shifting the irradiation position, the particles 65p are deposited and joined together like strings of beads, into the form of columns, to form the negative electrode nanocolumns 65 standing together in large numbers.

Meanwhile, in “lid nanocolumn formation process S3” (see FIG. 7), a pulse oscillation laser beam LC is applied to the first lid seal portion 31 of the case lid member 30Z while shifting the irradiation position (see FIG. 8) to form the numerously standing first lid nanocolumns 35 on the outer surface 31m and inner surface 31n of the first lid seal portion 31. The pulse oscillation laser beam LC is also applied to the second lid seal portion 32 of the case lid member 30Z while shifting the irradiation position to form the numerously standing second lid nanocolumns 36 on the outer surface 32m and inner surface 32n of the second lid seal portion 32. As described above (see also FIG. 4), the first lid nanocolumns 35 and second lid nanocolumns 36 are formed by joining the particles 35p, 36p made of aluminum and aluminum oxide together like strings of beads, into the form of columns. In this embodiment, the laser irradiation conditions are substantially identical with those in the positive electrode nanocolumn formation process S1.

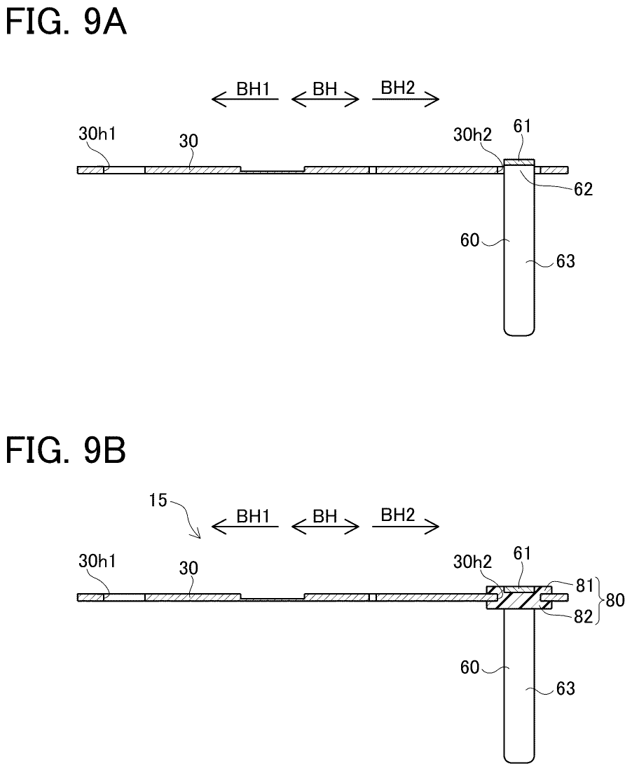

Next, in “second insert molding process S4” (see FIG. 7), in a condition where the negative terminal member 60 is inserted through the second insertion hole 30h2 of the case lid member 30, the second resin member 80 is formed by insert molding (see FIG. 9A and FIG. 9B), using the second resin material 85 having the resin material flexural modulus E in the above-indicated range.

More specifically, the second insert molding process S4 is carried out using a molding die (not shown) having an upper die and a lower die. First, the case lid member 30 is placed at a predetermined position of the lower die, and the negative terminal member 60 is inserted through the second insertion hole 30h2 of the case lid member 30 (see FIG. 9A). Then, the upper die is moved toward the lower die to close the molding die. Next, the molten second resin material 85 is injected into the cavity of the molding die. At this time, the second resin material 85 fills gaps between the numerously standing negative electrode nanocolumns 65 of the negative terminal seal portion 62 and gaps between the numerously standing second lid nanocolumns 36 of the second lid seal portion 32, to form the second resin member 80 hermetically joined to the negative terminal seal portion 62 and the second lid seal portion 32 (see FIG. 9B). Then, a lid assembly 15 with the negative terminal member 60 fixed to the case lid member 30 via the second resin member 80 is removed from the molding die.

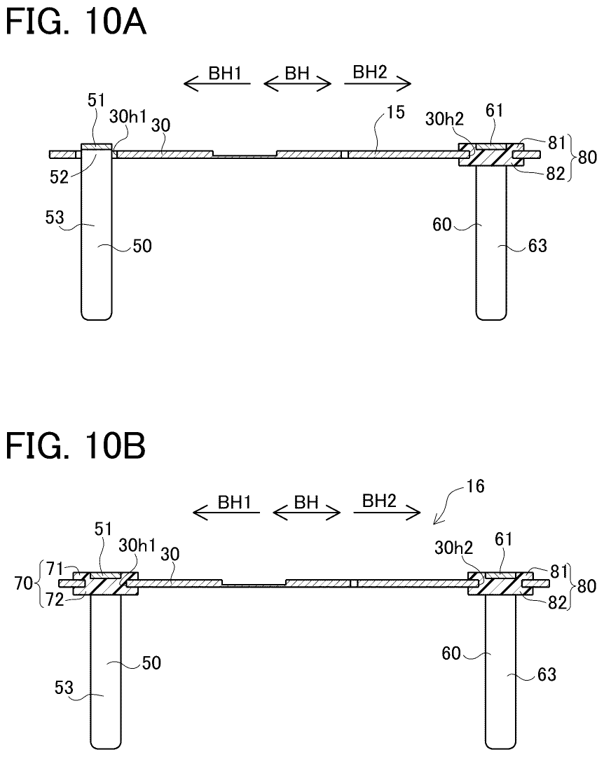

Next, in “first insert molding process S5” (see FIG. 7), in a condition where the positive terminal member 50 is inserted through the first insertion hole 30h1 of the case lid member 30 of the lid assembly 15 described above, the first resin member 70 is formed by insert molding (see FIG. 10A and FIG. 10B), using the first resin material 75 having the resin material linear expansion coefficient α within the above-indicated range.

More specifically, the first insert molding process S5 is carried out using a molding die (not shown) having an upper die and a lower die. First, the lid assembly 15 is placed at a predetermined position of the lower die, and the positive terminal member 50 is inserted through the first insertion hole 30h1 of the case lid member 30 (see FIG. 10A). Then, the upper die is moved toward the lower die to close the molding die. Next, the molten first resin material 75 is injected into the cavity of the molding die. At this time, the first resin material 75 fills gaps between the numerously standing positive electrode nanocolumns 55 of the positive terminal seal portion 52 and gaps between the numerously standing first lid nanocolumns 35 of the first lid seal portion 31, to form the first resin member 70 hermetically joined to the positive terminal seal portion 52 and the first lid seal portion 31 (see FIG. 10B). Then, a lid assembly 16 (in which the positive terminal member 50 is fixed to the case lid member 30 via the first resin member 70, and the negative terminal member 60 is fixed to the case lid member 30 via the second resin member 80) is removed from the molding die.

Next, in “electrode body connection process S6” (see FIG. 7), the electrode body 40 obtained by stacking the positive electrode sheets 41, negative electrode sheets 42, and separators 43 is prepared, and the positive terminal inner portion 53 of the positive terminal member 50 as a part of the lid assembly 16 described above is welded to the positive current collector 40c of the electrode body 40. Also, the negative terminal inner portion 63 of the negative terminal member 60 as a part of the lid assembly 16 is welded to the negative current collector 40d of the electrode body 40. The electrode body 40 is then wrapped with the bag-like insulating holder 7.

Next, in “electrode body housing and case formation process S7,” the case body 20 is prepared, the electrode body 40 covered with the insulating holder 7 described above is inserted into the case body 20, and the opening portion 20c of the case body 20 is closed with the case lid member 30. Then, the opening portion 20c of the case body 20 and the peripheral portion 30f of the case lid member 30 are laser welded hermetically over the entire circumference to form the case 10 with the electrode body 40 housed inside.

Next, in “pouring and sealing process S8,” the electrolyte 5 is poured into the case 10 through the liquid inlet 30k, so that the electrode body 40 is impregnated with the electrolyte 5. The liquid inlet 30k is then covered from the outside with the sealing member 12, and the sealing member 12 is laser welded hermetically to the case 10.

Next, in “initial charging and aging process S9,” a charging device (not shown) is connected to the battery 1 to perform initial charging on the battery 1. Then, the initially charged battery 1 is left to stand for a predetermined time so that the battery 1 is aged. In this manner, the battery 1 is completed.

### Test Results

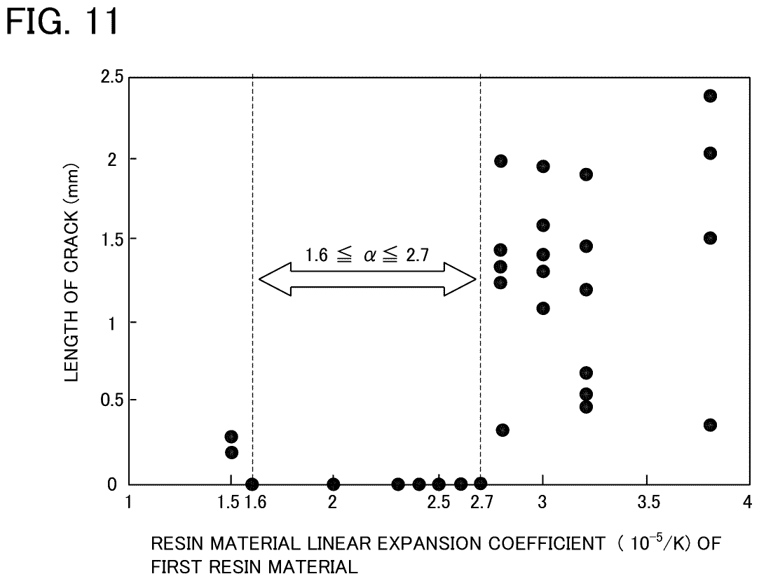

Next, the results of tests conducted to verify the effects of the disclosure will be described (see FIG. 11 to FIG. 14). First, a plurality of first resin materials 75 with different magnitudes of resin material linear expansion coefficients α was used to form the first resin members 70 of the positive electrodes, respectively, by insert molding. More specifically, for each of the first resin materials 75, only the positive electrode nanocolumn formation process S1, lid nanocolumn formation process S3, and first insert molding process S5 described above were performed to obtain a lid assembly in which only the positive terminal member 50 was fixed to the case lid member 30 via the first resin member 70.

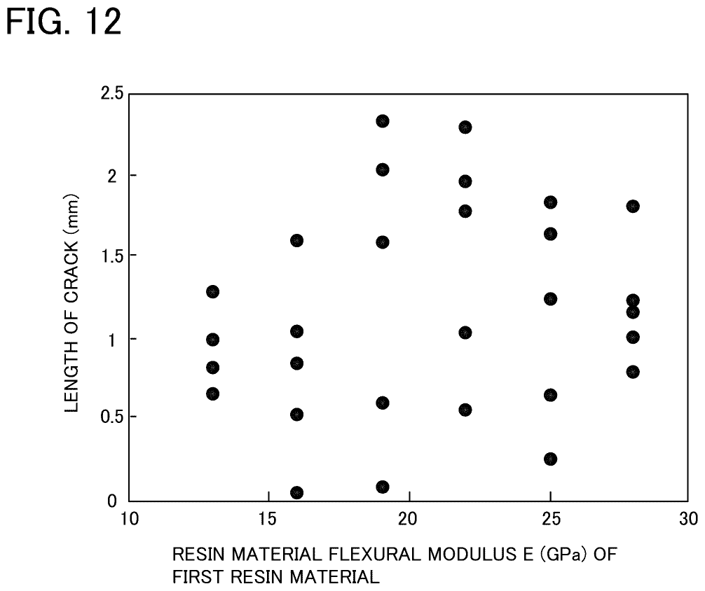

Then, the lid assemblies using the respective first resin materials 75 were subjected to a cooling and heating cycle test in the temperature range of −40° C. to 65° C., taking account of the operating temperature conditions of the battery. More specifically, the lid assembly was subjected to 3650 cycles of cooling and heating, using a liquid bath tester, such that the lid assembly was immersed in a liquid bath at −40° C. for 3 minutes and then immersed in a liquid bath at 65° C. for 3 minutes in one cycle. Then, for each lid assembly, the length of cracks appearing in a region of the first resin member 70 near its boundary with the positive terminal member 50 was measured. The results are all shown in FIG. 11. In FIG. 11, the lid assemblies in which no cracks appeared in the first resin members 70 are indicated with the crack length=0.0 mm. This also applies to the crack length in FIG. 12 to FIG. 14 which will be described below.

As is apparent from the graph in FIG. 11, when the first resin member 70 is molded using the first resin material 75 with the resin material linear expansion coefficient α of 1.5×10⁻⁵ (1/K) or less or 2.8×10⁻⁵ (1/K) or more, and the cooling and heating cycle test is conducted, cracks appear in the first resin member 70. In contrast, when the first resin member 70 is molded using the first resin material 75 with the resin material linear expansion coefficient α in the range of 1.6×10⁻⁵ to 2.7×10⁻⁵ (1/K), and the cooling and heating cycle tests is conducted, no cracks appear in the first resin member 70. Thus, for the positive electrode, it is found desirable to control the resin material linear expansion coefficient α of the first resin material 75 to within the range of 1.6×10⁻⁵ to 2.7×10⁻⁵ (1/K).

Next, a plurality of first resin materials 75 with different magnitudes of the resin material flexural modulus E was used to form the first resin members 70 by insert molding. Then, the cooling and heating cycle test was conducted as described above, and the length of cracks appearing in the first resin members 70 was measured. The results are all shown in FIG. 12. Although the details are omitted, the magnitude of the resin material linear expansion coefficient α of the first resin material 75 of each sample shown in FIG. 12 is outside the above-indicated range (1.6×10⁻⁵ to 2.7×10⁻⁵ (1/K)).

As is apparent from the graph in FIG. 12, the magnitude of the resin material flexural modulus E of the first resin material 75 has little effect on the presence or absence of cracks, and cracks appear in the first resin member 70 even if the magnitude of the resin material flexural modulus E is changed. Accordingly, to prevent cracks from appearing in the first resin member 70, it is desirable to control the resin material linear expansion coefficient α of the first resin material 75 to within the range of 1.6×10⁻⁵ to 2.7×10⁻⁵ (1/K), as described above.

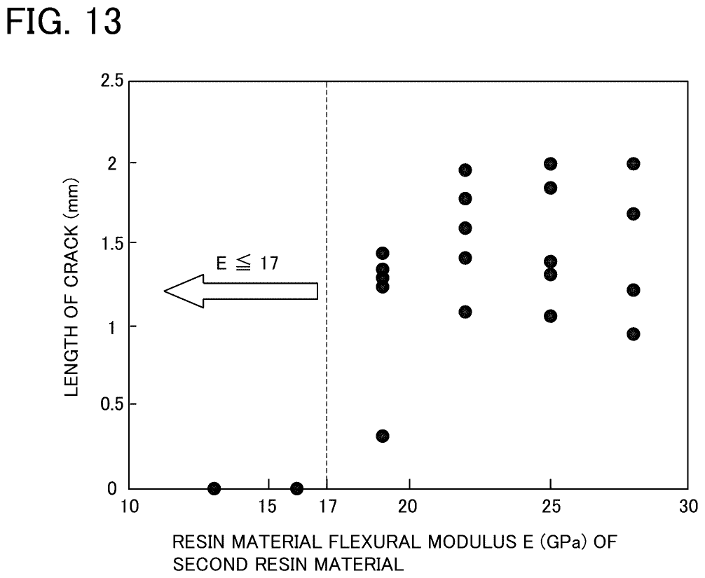

Next, a plurality of second resin materials 85 with different magnitudes of the resin material flexural modulus E was used to form the second resin members 80 of the negative electrodes by insert molding. More specifically, for each of the second resin materials 85, only the negative electrode nanocolumn formation process S2, lid nanocolumn formation process S3, and second insert molding process S4 described above were performed to obtain the lid assembly 15 (see FIG. 9B) in which only the negative electrode terminal member 60 was fixed to the case lid member 30 via the second resin member 80. The lid assemblies 15 were then subjected to the cooling and heating cycle test described above, and the length of cracks appearing in a region of the second resin member 80 near its boundary with the negative terminal member 60 was measured. The results are all shown in FIG. 13.

As is apparent from the graph in FIG. 13, when the second resin member 80 is molded using the second resin material 85 with a resin material flexural modulus E of 19 GPa or higher and subjected to the cooling and heating cycle test, cracks appear in the second resin member 80. In contrast, when the second resin member 80 is molded using the second resin material 85 with a resin material flexural modulus E of 17 GPa or less and subjected to the cooling and heating cycle test, no cracks appear in the second resin member 80. Thus, for the negative electrode, it is found desirable to control the resin material flexural modulus E of the second resin material 85 to 17 GPa or less.

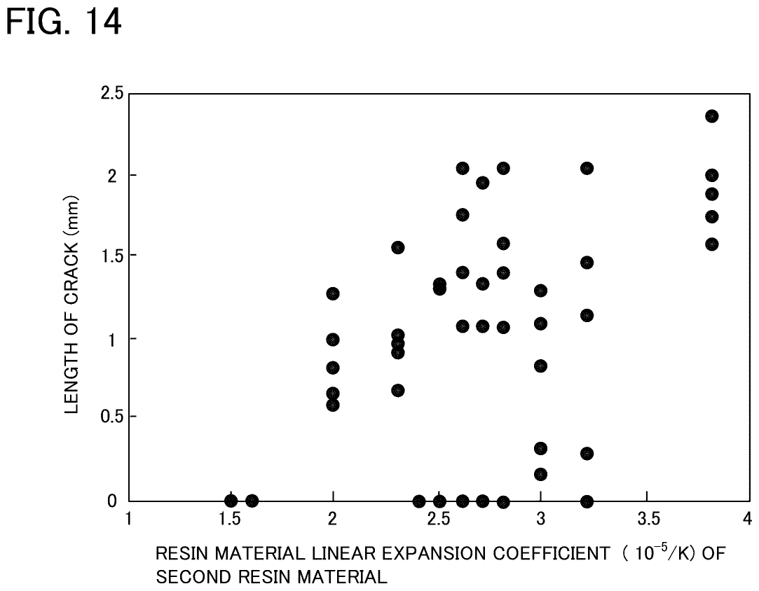

Next, the second resin members 80 were insert molded using a plurality of second resin materials 85 with different resin material linear expansion coefficients α. The second resin members 80 were then subjected to the cooling and heating cycle test described above, and the length of cracks appearing in the respective second resin members 80 was measured. The results are all shown in FIG. 14. Although the details are omitted, the magnitude of the resin material flexural modulus E of the second resin material 85 of each sample shown in FIG. 14 is outside the above-indicated range (17 GPa or less).

It is apparent from the graph in FIG. 14 that the magnitude of the resin material linear expansion coefficient α of the second resin material 85 has little effect on the presence or absence of cracks. Accordingly, to prevent cracks from appearing in the second resin member 80, it is desirable to control the resin material flexural modulus E of the second resin material 85 to 17 GPa or less as described above.

As described above, in the method of manufacturing the battery 1, the first resin member 70 is insert molded in the first insert molding process S5 using the first resin material 75 having a resin material linear expansion coefficient α within the above-indicated range, so that cracks are less likely or unlikely to be generated in the first resin member 70 during molding, and a good seal between the positive terminal member 50 and the first resin member 70 can be maintained. In the second insert molding process S4, the second resin member 80 is insert molded using the second resin material 85 having a resin material flexural modulus E within the above-indicated range, so that cracks are less likely or unlikely to be generated in the second resin member 80 during molding, and a good seal between the negative terminal member 60 and the second resin member 80 can be maintained.

The positive terminal member 50 made of aluminum has a larger linear expansion coefficient than the negative terminal member 60 made of copper. Therefore, if the first insert molding process S5 is performed first, cracks are easily generated in the first resin member 70 due to temperature changes in the subsequent second insert molding process S4. In contrast, in this embodiment, since the second insert molding process S4 is performed first, the first resin member 70 is not present in the second insert molding process S4 (see FIG. 9A and FIG. 9B), and no cracks appear in the first resin member 70.

Also, in this embodiment, the positive electrode nanocolumns 55 are formed on the surface 52m of the positive terminal seal portion 52 by irradiating the surface 52m with the laser beam LC in the positive electrode nanocolumn formation process S1 as described above, so that the positive electrode nanocolumns 55 can be easily formed on the positive terminal seal portion 52. Since the first resin member 70 is molded with the first resin material 75 filling gaps between the positive electrode nanocolumns 55 in the first insert molding process S5, the joint strength between the positive terminal seal portion 52 of the positive terminal member 50 and the first resin member 70 can be increased, and a particularly good seal between the positive terminal member 50 and the first resin member 70 can be maintained.

The negative electrode nanocolumns 65 are formed on the surface 62m of the negative terminal seal portion 62 by irradiating the surface 62m with the laser beam LC in the negative electrode nanocolumn formation process S2 as described above, so that the negative electrode nanocolumns 65 can be easily formed on the negative terminal seal portion 62. Since the second resin member 80 is molded with the second resin material 85 filling gaps between the negative electrode nanocolumns 65 in the second insert molding process S4, the joint strength between the negative terminal seal portion 62 of the negative terminal member 60 and the second resin member 80 can be increased, and a particularly good seal between the negative terminal member 60 and the second resin member 80 can be maintained.

While the disclosure has been described in the light of the embodiment, it is to be understood that the disclosure is not limited to the embodiment, but may be applied by making changes as needed, without departing from the principle of the disclosure.

### REFERENCE SIGNS LIST

1 Battery (Power storage device)
10 Case
30 Case lid member (Case member)
30h1 First insertion hole
30h2 Second insertion hole
40 Electrode body
50 Positive terminal member (First terminal member)
52 Positive terminal seal portion (First terminal seal portion)
52m Surface (of positive terminal seal portion)
55 Positive electrode nanocolumn (First nanocolumn)
55p Particle
60 Negative terminal member (Second terminal member)
62 Negative terminal seal portion (Second terminal seal portion)
62m Surface (of negative terminal seal portion)
65 Negative electrode nanocolumn (Second nanocolumn)
65p Particle
70 First resin member
75 First resin material
76 First main resin
77 First elastomer
78 First filler
80 Second resin member
85 Second resin material
86 Second main resin
87 Second elastomer
88 Second filler
α Resin material linear expansion coefficient
E Resin material flexural modulus
LC Laser beam
S1 Positive electrode nanocolumn formation process (First nanocolumn forming)
S2 Negative electrode nanocolumn formation process (Second nanocolumn forming)
S4 Second insert molding process
S5 First insert molding process

What is claimed is:

1. A power storage device comprising:
a case member having a first insertion hole and a second insertion hole;
a first terminal member comprising aluminum and inserted through the first insertion hole of the case member;
a second terminal member comprising copper and inserted through the second insertion hole of the case member;
a first resin member that is insert molded and hermetically joined to the case member and the first terminal member while insulating the case member and the first terminal member from each other, to fix the first terminal member to the case member; and
a second resin member that is insert molded and hermetically joined to the case member and the second terminal member while insulating the case member and the second terminal member from each other, to fix the second terminal member to the case member, wherein
the first resin member comprises a first resin material having a resin material linear expansion coefficient α within a range of 1.6×10⁻⁵ to 2.7×10⁻⁵ (1/K) (1.6×10⁻⁵≤α≤2.7×10⁻⁵), and
the second resin member comprises a second resin material that is different from the first resin material and has a resin material flexural modulus E of 17 GPa or less (E≤17).

2. The power storage device according to claim 1, wherein:
the first resin material includes a thermoplastic first main resin, a thermoplastic first elastomer, and a first filler; and
the second resin material includes a thermoplastic second main resin, a thermoplastic second elastomer, and a second filler.

3. The power storage device according to claim 1, wherein:
the first terminal member includes a first terminal seal portion to which the first resin member is hermetically joined;
first nanocolumns with a height of 50 nm or more formed by joining particles containing aluminum and having a diameter of 100 nm or less together like strings of beads, into the form of columns, stand numerously on a surface of the first terminal seal portion;
the first resin member is hermetically joined to the first terminal seal portion with the first resin material filling gaps between the first nanocolumns standing numerously;
the second terminal member includes a second terminal seal portion to which the second resin member is hermetically joined;
second nanocolumns with a height of 50 nm or more formed by joining particles containing copper and having a diameter of 100 nm or less together like strings of beads, into the form of columns, stand numerously on a surface of the second terminal seal portion; and
the second resin member is hermetically joined to the second terminal seal portion with the second resin material filling gaps between the second nanocolumns standing numerously.

4. A method of manufacturing a power storage device including
a case member having a first insertion hole and a second insertion hole,
a first terminal member comprising aluminum and inserted through the first insertion hole of the case member,
a second terminal member comprising copper and inserted through the second insertion hole of the case member,
a first resin member that is insert molded and hermetically joined to the case member and the first terminal member while insulating the case member and the first terminal member from each other, to fix the first terminal member to the case member, and
a second resin member that is insert molded and hermetically joined to the case member and the second terminal member while insulating the case member and the second terminal member from each other, to fix the second terminal member to the case member, wherein
the first resin member comprises a first resin material having a resin material linear expansion coefficient α within a range of 1.6×10⁻⁵ to 2.7×10⁻⁵ (1/K) (1.6×10⁻⁵≤α≤2.7×10⁻⁵), and
the second resin member comprises a second resin material that is different from the first resin material and has a resin material flexural modulus E of 17 GPa or less (E≤17),
the method comprising:
a first insert molding of insert molding the first resin member, using the first resin material having the resin material linear expansion coefficient α, in a condition where the first terminal member is inserted through the first insertion hole of the case member; and
a second insert molding of insert molding the second resin member, using the second resin material having the resin material flexural modulus E, in a condition where the second terminal member is inserted through the second insertion hole of the case member.

5. The method according to claim 4, wherein the second insert molding is performed first, and the first insert molding is then performed.

6. The method according to claim 4, wherein
the first terminal member includes a first terminal seal portion to which the first resin member is hermetically joined,
first nanocolumns with a height of 50 nm or more formed by joining particles containing aluminum and having a diameter of 100 nm or less together like strings of beads, into the form of columns, stand numerously on a surface of the first terminal seal portion,
the first resin member is hermetically joined to the first terminal seal portion with the first resin material filling gaps between the first nanocolumns standing numerously,
the second terminal member includes a second terminal seal portion to which the second resin member is hermetically joined,
second nanocolumns with a height of 50 nm or more formed by joining particles containing copper and having a diameter of 100 nm or less together like strings of beads, into the form of columns, stand numerously on a surface of the second terminal seal portion, and
the second resin member is hermetically joined to the second terminal seal portion with the second resin material filling gaps between the second nanocolumns standing numerously, the method further comprising:
a first nanocolumn forming of applying a pulse oscillation laser beam to the first terminal seal portion of the first terminal member while shifting an irradiation position, before the first insert molding, to form the first nanocolumns standing numerously on the first terminal seal portion; and
a second nanocolumn forming of applying a pulse oscillation laser beam to the second terminal seal portion of the second terminal member while shifting an irradiation position, before the second insert molding, to form the second nanocolumns standing numerously on the second terminal seal portion, wherein
the first insert molding comprises molding the first resin member while filling the gaps between the numerously standing first nanocolumns of the first terminal seal portion with the first resin material, and
the second insert molding comprises molding the second resin member while filling the gaps between the numerously standing second nanocolumns of the second terminal seal portion with the second resin material.

7. The power storage device according to claim 2, wherein:
the first terminal member includes a first terminal seal portion to which the first resin member is hermetically joined;
first nanocolumns with a height of 50 nm or more formed by joining particles containing aluminum and having a diameter of 100 nm or less together like strings of beads, into the form of columns, stand numerously on a surface of the first terminal seal portion;
the first resin member is hermetically joined to the first terminal seal portion with the first resin material filling gaps between the first nanocolumns standing numerously;
the second terminal member includes a second terminal seal portion to which the second resin member is hermetically joined;
second nanocolumns with a height of 50 nm or more formed by joining particles containing copper and having a diameter of 100 nm or less together like strings of beads, into the form of columns, stand numerously on a surface of the second terminal seal portion; and
the second resin member is hermetically joined to the second terminal seal portion with the second resin material filling gaps between the second nanocolumns standing numerously.

8. The method according to claim 5, wherein
the first terminal member includes a first terminal seal portion to which the first resin member is hermetically joined,
first nanocolumns with a height of 50 nm or more formed by joining particles containing aluminum and having a diameter of 100 nm or less together like strings of beads, into the form of columns, stand numerously on a surface of the first terminal seal portion,
the first resin member is hermetically joined to the first terminal seal portion with the first resin material filling gaps between the first nanocolumns standing numerously,
the second terminal member includes a second terminal seal portion to which the second resin member is hermetically joined,
second nanocolumns with a height of 50 nm or more formed by joining particles containing copper and having a diameter of 100 nm or less together like strings of beads, into the form of columns, stand numerously on a surface of the second terminal seal portion, and
the second resin member is hermetically joined to the second terminal seal portion with the second resin material filling gaps between the second nanocolumns standing numerously, the method further comprising:
a first nanocolumn forming of applying a pulse oscillation laser beam to the first terminal seal portion of the first terminal member while shifting an irradiation position, before the first insert molding, to form the first nanocolumns standing numerously on the first terminal seal portion; and
a second nanocolumn forming of applying a pulse oscillation laser beam to the second terminal seal portion of the second terminal member while shifting an irradiation position, before the second insert molding, to form the second nanocolumns standing numerously on the second terminal seal portion, wherein
the first insert molding comprises molding the first resin member while filling the gaps between the numerously standing first nanocolumns of the first terminal seal portion with the first resin material, and
the second insert molding comprises molding the second resin member while filling the gaps between the numerously standing second nanocolumns of the second terminal seal portion with the second resin material.
